(19) United States
(12) Patent Application Publication
(10) Pub. No.: US 2022/0245535 A1
(43) Pub. Date: Aug. 4, 2022

(54) SYSTEM AND METHOD FOR DATA ANALYTICS FEATURE SELECTION

(71) Applicant: Chevron U.S.A. Inc., San Ramon, CA (US)

(72) Inventor: Julian A. Thorne, Houston, TX (US)

(21) Appl. No.: 17/164,115

(22) Filed: Feb. 1, 2021

(51) Int. Cl. G06Q 10/06; G06N 3/02

(52) U.S. Cl. CPC G06Q 10/067; G06N 3/02

(57) ABSTRACT

A method is described for data analytics including receiving a dataset representative of a subsurface volume of interest; identifying at least two features in the dataset; performing optimization methods to fit the at least two features to a response variable; calculating partial dependency functions of the at least two features; calculating a simplicity of each of the partial dependency functions; calculating an importance of each of the at least two features; selecting at least one highly ranked feature based on a combination of the simplicity and the importance; and performing optimization methods to fit the at least one highly ranked feature to a response variable. The method may be executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for data analytics and, in particular, to a method of data analytics feature selection using partial dependence simplicity.

### BACKGROUND

Data analytics, alternatively called data mining or data science, uses optimization methods to fit non-linear functions of explanatory variables (features) to a response variable. Since the optimization methods are so non-linear spurious correlations are an inevitable outcome of this process if there are many features in the function. To mitigate this problem a process called feature selection is employed. In feature selection explanatory variables are removed from the function one at a time depending on which is the least statistically significant. If the fit with fewer features is better than the fit with many features, then feature selection has improved the process. Correct evaluation of statistical significance is key to this process. For a class of solutions that is most commonly employed, statistical significance is evaluated based on feature importance. Importance is a measure of how much that particular feature affects the prediction response which may be determined, for example, by the permutation feature importance technique. Unfortunately, highly nonlinear overly complex response functions can have high measures of feature importance. A general principle of the scientific method is to search for a simple solution before resorting to a complex solution. For this reason, the tendency of current feature selection methods to use overly complex response functions is not preferred. However, this will remove potentially valuable information that is present in the original feature vectors.

There is an opportunity to improve feature selection for improved data analytics.

### SUMMARY

In accordance with some embodiments, a method of data analytics including receiving a dataset representative of a subsurface volume of interest; identifying at least two features in the dataset; performing optimization methods to fit the at least two features to a response variable; calculating the partial dependency functions of the at least two features; calculating a simplicity of each of the partial dependency functions; calculating an importance of the at least two features; selecting at least one highly ranked feature based on a combination of the simplicity and the importance; and performing optimization methods to fit the at least one highly ranked feature to a response variable is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates elements of a method of data analytics, in accordance with some embodiments; and

FIG. 2 is a block diagram illustrating a data analytics system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of data analytics. The data analytics methods and systems provided herein may be used for prediction of hydrocarbon production.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Hydrocarbon exploration and production results in a huge amount of data. This may include geological data, geophysical data, and petrophysical data. It may also include production data. Data analytics can extract meaning from this data in order to make predictions for identifying and producing hydrocarbons. For example, well-log petrophysical data and seismic attributes can be used to predict the observed variations in gas or oil production across a field or basin. Data analytic tools such as an ensemble of regression or classification decision trees can be trained on collocated well-logs, seismic, and production data to generate a prediction function. The prediction function is then applied on interpolated petrophysical property maps or volumes and the seismic attributes to predict the desired response variables such as estimated ultimate recovery. Since well completion parameters can also influence production data analytics is also used to normalize out these effects.

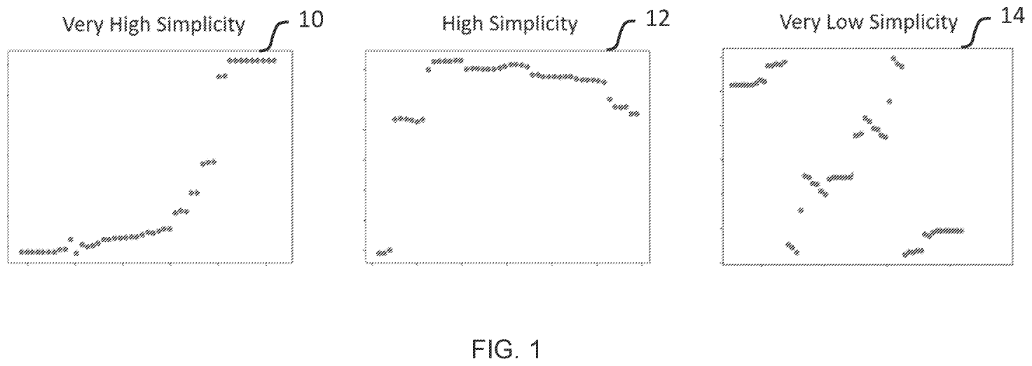

In this invention an additional component of statistical significance is added to the process of feature selection. This component is a measure of the simplicity of the partial dependency function for the explanatory variable under consideration. FIG. 1 illustrates 3 partial dependency functions of varying simplicity. In the function of very high simplicity 10, the response shows a monotonic increase. In the function of high simplicity 12, the response shows a simple pattern where the function first increases and then decreases. In the function of very low simplicity 14, the response has a much more complicated pattern. There are kinks in the function as well as many changes in the sign of the gradient. A quantitative measure of simplicity is given by the integral of the absolute value of the gradient across the partial dependency function. Both feature importance and feature simplicity can be combined in the feature selection process. A combination which requires no parameters is to give these characteristics equal weight. A non-parametric way of combining feature simplicity and feature importance is to rank features first by simplicity and 2nd by importance. The ranks are added together, and the combined rank is then used for the final ranking.

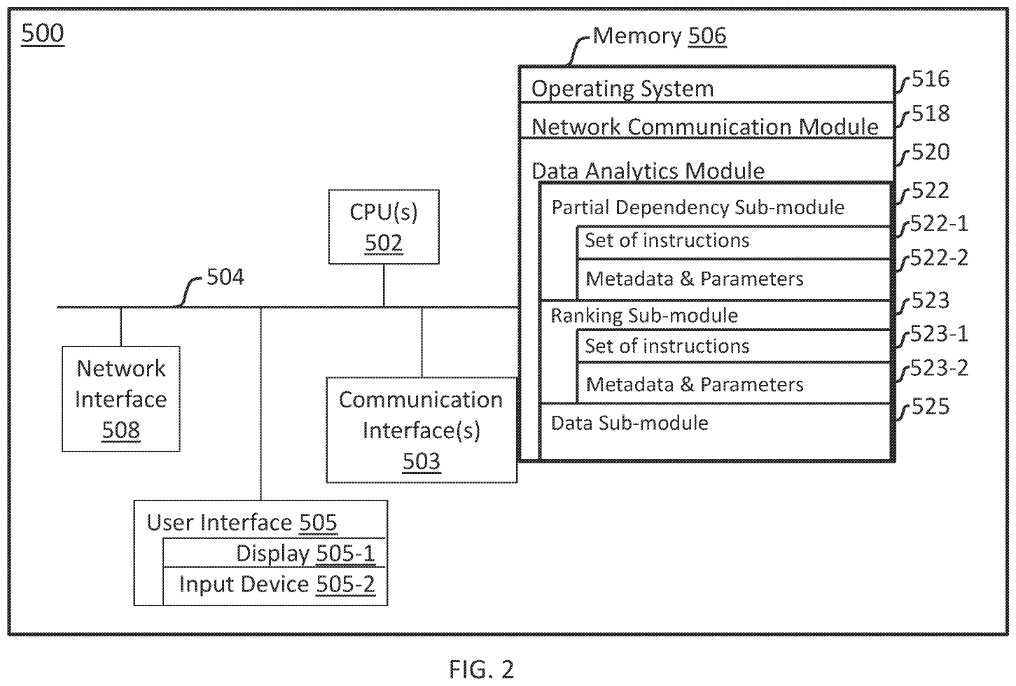

FIG. 2 is a block diagram illustrating a data analytics system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the data analytics system 500 includes one or more processing units (CPUs) 502, one or more network interfaces 508 and/or other communications interfaces 503, memory 506, and one or more communication buses 504 for interconnecting these and various other components. The data analytics system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store any type of data.

In some embodiments, memory 506 or the non-transitory computer readable storage medium of memory 506 stores the following programs, modules and data structures, or a subset thereof including an operating system 516, a network communication module 518, and a data analytics module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the data analytics module 520 executes the operations disclosed herein. Data analytics module 520 may include data sub-module 525, which handles the dataset including all available geological, geophysical, petrophysical, and production data. This data is supplied by data sub-module 525 to other sub-modules.

Partial dependency sub-module 522 contains a set of instructions 522-1 and accepts metadata and parameters 522-2 that will enable it to determine the partial dependency of features of the data. The ranking sub-module 523 contains a set of instructions 523-1 and accepts metadata and parameters 523-2 that will enable it to calculate the simplicity and importance of the features. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing data and generating images. For example, any of the sub-modules may optionally be able to generate a display that would be sent to and shown on the user interface display 505-1. In addition, any of the data or processed data products may be transmitted via the communication interface(s) 503 or the network interface 508 and may be stored in memory 506.

The method described above is, optionally, governed by instructions that are stored in computer memory or a non-transitory computer readable storage medium (e.g., memory 506 in FIG. 2) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, the method is described as being performed by a computer system, although in some embodiments, various operations of the method are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of data analytics, comprising:
a. receiving, at one or more computer processors, a dataset representative of a subsurface volume of interest;
b. identifying, via the one or more computer processors, at least two features in the dataset;
c. performing a first optimization method to fit the at least two features to a response variable;
d. calculating, via the one or more computer processors, partial dependency functions of the at least two features;
e. calculating a simplicity of each of the partial dependency functions;
f. calculating an importance of each of the at least two features;
g. selecting at least one highly ranked feature based on a combination of the simplicity and the importance for each of the at least two features; and
h. performing a second optimization method to fit the at least one highly ranked feature to a response variable.

2. The method of claim 1 wherein the response variable is hydrocarbon production.

3. The method of claim 1 wherein the performing the second optimization method generates a neural network.

4. The method of claim 3 further comprising using the neural network with a second dataset to generate a predicted response variable.

5. The method of claim 1 wherein the combination of the simplicity and the importance comprises ranking the at least two features first by the simplicity to generate a first rank and second by the importance to generate a second rank and adding the first rank and the second rank together to get a final rank for each feature.

6. The method of claim 1 wherein the calculating the simplicity is done by calculating an integral of an absolute value of a gradient across the partial dependency functions.

7. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a dataset representative of a subsurface volume of interest;
b. identify, via the one or more processors, at least two features in the dataset;
c. perform a first optimization method to fit the at least two features to a response variable;
d. calculate partial dependency functions of the at least two features;
e. calculate a simplicity of each of the partial dependency functions;
f. calculate an importance of each of the at least two features;
g. select at least one highly ranked feature based on a combination of the simplicity and the importance; and
h. perform a second optimization method to fit the at least one highly ranked feature to a response variable.

8. The system of claim 7 wherein the response variable is hydrocarbon production.

9. The system of claim 7 wherein the performing the second optimization method generates a neural network.

10. The system of claim 9 further comprising using the neural network with a second dataset to generate a predicted response variable.

11. The system of claim 7 wherein the combination of the simplicity and the importance comprises ranking the at least two features first by the simplicity to generate a first rank and second by the importance to generate a second rank and adding the first rank and the second rank together to get a final rank for each feature.

12. The system of claim 7 wherein the calculating the simplicity is done by calculating an integral of an absolute value of a gradient across the partial dependency functions.

13. A non-transitory computer readable storage medium storing one or more programs, the one or more programs comprising instructions, which when executed by an electronic device with one or more processors and memory, cause the device to a. receive, at the one or more processors, a dataset representative of a subsurface volume of interest;
b. identify, via the one or more processors, at least two features in the dataset;
c. perform a first optimization method to fit the at least two features to a response variable;
d. calculating partial dependency functions of the at least two features;
e. calculating a simplicity of each of the partial dependency functions;
f. calculating an importance of each of the at least two features;
g. selecting at least one highly ranked feature based on a combination of the simplicity and the importance; and
h. perform a second optimization method to fit the at least one highly ranked feature to a response variable.

14. The device of claim 13 wherein the response variable is hydrocarbon production.

15. The device of claim 13 wherein the performing the second optimization method generates a neural network.

16. The device of claim 15 further comprising using the neural network with a second dataset to generate a predicted response variable.

17. The device of claim 13 wherein the combination of the simplicity and the importance comprises ranking the at least two features first by the simplicity to generate a first rank and second by the importance to generate a second rank and adding the first rank and the second rank together to get a final rank for each feature.

18. The device of claim 13 wherein the calculating the simplicity is done by calculating an integral of an absolute value of a gradient across the partial dependency functions.
